(19) United States
(12) Patent Application Publication
(10) Pub. No.: US 2018/0121966 A1
(43) Pub. Date: May 3, 2018

(54) DETERMINING EXTENSION OF CREDIT TO A USER OF AN ONLINE SYSTEM FOR ADVERTISING SERVICES PROVIDED BY THE ONLINE SYSTEM

(71) Applicant: Facebook, Inc., Menlo Park, CA (US)

(72) Inventors: Nathan Gaston Schmidt, San Francisco, CA (US); Mark Ford Westling, Menlo Park, CA (US); Aparna Nemana, Sunnyvale, CA (US)

(21) Appl. No.: 15/340,858

(22) Filed: Nov. 1, 2016

(51) Int. Cl. G06Q 30/02; H04L 29/08; G06Q 20/10

(52) U.S. Cl. CPC G06Q 30/0273; G06Q 20/102; G06Q 30/0277; H04L 67/306

(57) ABSTRACT

An online system allows online system users to create advertising accounts that are each associated with a user profile of a user and an amount of credit to purchase advertising services provided by the online system. To allocate more advertising accounts and/or credit to users who are unlikely to default on their payments while limiting the same for users who are likely to do so, the online system determines a trusted connection score for a user requesting to create an advertising account and/or to be allocated an amount of credit. The trusted connection score indicates a measure of trustworthiness of the user and is determined based on the user's connectivity to a network of trusted users, in which each user of the trusted network is associated with at least a threshold measure of trustworthiness. Based on the score, the online system may determine whether to grant or deny the request.

### BACKGROUND

This disclosure relates generally to online systems, and more specifically to extending credit to a user of an online system for advertising services provided by the online system.

An online system allows its users to connect and communicate with other online system users. Users create profiles on the online system that are tied to their identities and include information about the users, such as interests and demographic information. The users may be individuals or entities such as corporations or charities. Because of the popularity of online systems and the significant amount of user-specific information maintained by online systems, an online system provides advertisers with abundant opportunities to increase awareness about their products or services by presenting advertisements to online system users. For example, advertisements presented to users allow an advertiser to gain public attention for products or services and to persuade online system users to take an action regarding the advertiser's products, services, opinions, or causes.

Conventionally, online systems require advertisers to create advertising accounts that are associated with the advertisers' user profiles in order to request advertising services provided by the online systems. Since the amounts that advertisers spend on advertising services may fluctuate from time to time (e.g., during different times of the year) and from advertiser to advertiser (e.g., based on advertisement bid amounts, advertising budgets, etc.), extending an amount of credit to advertisers and allowing them to subsequently pay for the advertising services provided during a given period of time is more suitable than charging a flat fee. For example, an online system may charge an advertiser for each presentation of an advertisement to an online system user (i.e., each “impression”) and/or for each interaction with an advertisement by an online system user up to the amount of credit allocated to an advertising account associated with the advertiser's user profile. At the end of a specified period (e.g., when the credit limit or the end of a billing cycle is reached), the online system may send an invoice to the advertiser for the balance owed.

Advertising accounts provide a convenient way for online systems to manage billing for advertising services provided by the online systems and for advertisers to manage payment for those services. For example, an advertiser may pay for all advertising services provided by the online system during a specified period, rather than in a piecemeal fashion (e.g., at the time of each impression of an advertisement or at the time of each interaction with an advertisement by an online system user). Advertising accounts also allow advertisers greater flexibility with regard to how payment may be made. For example, advertisers may link and/or save various payment methods to different advertising accounts (e.g., credit cards, withdrawals from bank accounts, PayPal®, etc.)

However, by allowing advertisers to pay for advertising services after the services have already been provided, online systems must be willing to assume financial risks inherent to extending credit to the advertisers. For example, advertisers that have created advertising accounts may not make payments on their accounts by the date the payments are due. Furthermore, even if online systems discourage advertisers from making late payments by charging additional fees or by imposing other types of penalties, in some instances, online systems may end up never collecting from an advertiser.

Online systems traditionally limit the risk that some advertisers will default on their payments by imposing standard credit limits across all advertising accounts (e.g., limits on the number of advertising accounts advertisers may create and/or limits on the amount of credit allocated to advertising accounts). For example, if an advertiser has created an advertising account for an advertising campaign on an online system, the online system may present advertisements included in the campaign to users of the online system and charge the advertiser for each presentation until such time as the amount of credit allocated to the account—the standard amount—has been exhausted, and then stop presenting the advertisements. In this example, the online system may resume presenting advertisements included in the campaign to online system users upon the occurrence of an event (e.g., the advertiser has paid the balance due on their advertising account, more credit is allocated to the advertising account, a new billing cycle has begun, etc.).

To further protect themselves, online systems may decrease credit limits from standard amounts for advertisers who have demonstrated a history of defaulting on payments. However, while decreasing credit limits only after advertisers have defaulted limits further risk that online systems will be unable to collect from the same advertisers, once advertisers have demonstrated a history of defaulting on payments, online systems may never recuperate their loss. Conversely, online systems may use a more conservative approach and proactively place low credit limits on all advertisers initially and increase the credit limits as advertisers demonstrate consistent payment histories. However, taking such an approach may prevent online systems from earning revenue that potentially may have been generated from advertisers that would not have defaulted on their payments in the first place.

### SUMMARY

An online system, such as an online advertising agency, allows users of the online system (e.g., entities such as businesses and organizations) to create advertising accounts that each are associated with a user profile of a user of the online system and an amount of credit extended to the user to purchase advertising services provided by the online system. For example, the credit in an advertising account may be used towards advertisements presented to users of the online system. To allow some users who will end up being good customers (e.g., users who are not likely to default on their payments) to create more advertising accounts and/or to extend more credit to such users, while limiting the number of accounts that may be created by users who will end up being bad customers (e.g., users who are likely to default on their payments) and/or to limit the amount of credit extended to such users, the online system determines a trusted connection score for a user who is a new advertising customer that indicates a measure of trustworthiness of the user based on their connections to other trusted users. The trusted connection score is determined based on the user's connectivity to a network of trusted users (i.e., a “trusted network”), in which each user of the trusted network is associated with at least a threshold measure of trustworthiness. The trusted network may include individual users, as well as entities such as advertisers, advertising agencies, etc.

Users of the trusted network may be identified based on historical information associated with each of the trusted users indicating at least a threshold measure of credit-worthiness. For example, an advertiser or advertising agency is considered a trusted user if it has at least three advertising accounts with the online system, actively uses the accounts every month, has spent at least $10,000 on advertising each year for at least the previous eight years, and has never defaulted on a payment to the online system in exchange for advertising services during those eight years. In some embodiments, the historical information used to identify users of the trusted network may correspond to a frequency or seasonality of advertisement purchases made by the users. For example, if a trusted user primarily purchases advertisements for sunblock, rather than using a total amount spent by the trusted user to determine the credit-worthiness of the user, the online system determines the credit-worthiness of the user based on the user's average monthly advertisement purchases during months in the summer and late spring.

In some embodiments, when identifying users of the trusted network, historical spending information associated with the users is discounted by an amount that the online system has not yet collected or by an amount charged by the online system that may be subject to reversal (e.g., chargeback of a disputed amount). For example, a user is included in the trusted network if the total amount the user spent on advertising in the previous year, when adjusted by any pending payments towards the total amount, is at least a threshold amount. The online system may identify amounts not yet collected by the online system and/or amounts that may be subject to reversal based on geographic information associated with users and/or payment information provided by the users. For example, different policies may apply to users located in different geographic locations, such that the timeframe within which a charge may be disputed may vary for different users based on their geographic location. As an additional example, recent payments made by credit cards may be subject to reversal while older payments made by credit cards and by withdrawals from a bank account are less likely to be subject to reversal.

For each user that requests to create an advertising account and/or to allocate an amount of credit to an existing advertising account associated with the user (i.e., “a requesting user”), the online system determines a trusted connection score for the requesting user. The online system determines the trusted connection score for the requesting user by identifying users of the trusted network and identifying connections between the requesting user and one or more users of the trusted network. Connections between the requesting user and users of the trusted network may be identified by accessing a graph (e.g., a social graph) maintained by the online system that includes several nodes and edges connecting the nodes, in which each node corresponds to an object maintained by the online system, (e.g., a requesting user and a trusted user) and each edge corresponds to a connection between two or more objects. A connection between the requesting user and a user of the trusted network may be characterized based on the degrees of separation between the users (e.g., the number of edges required to connect the requesting user to the trusted user in the social graph), such that one degree of separation separates users with a direct connection and more than one degree of separation separate users with an indirect connection. Therefore, the requesting user and a user of the trusted network may be connected by multiple connections (e.g., via a direct connection and multiple indirect connections).

Once the online system has identified the connections between the requesting user and users of the trusted network, the trusted connection score for the requesting user may be determined based at least in part on the connections. The trusted connection score for the requesting user may be determined based on the number of connections the requesting user has to the trusted network (e.g., number of different paths connecting the requesting user to the trusted network in a social graph). The trusted connection score for the requesting user also may be determined based on the degrees of separation between the requesting user and each of the users of the trusted network to which the requesting user is connected. For example, the trusted connection score is proportional to the trustworthiness of the requesting user, such that the greater the number of connections between the requesting user and the users of the trusted network and the fewer degrees of separation between the requesting user and each user of the trusted network to which the requesting user is connected, the higher the trusted connection score for the requesting user and thus, the greater the trustworthiness of the requesting user.

In various embodiments, the online system may use additional types of information to determine the trusted connection score for the requesting user. In one embodiment, the online system also determines the trusted connection score based on the number of connections the requesting user has to a network of bad customers (i.e., a network of untrusted users or “untrusted network”) and/or the degrees of separation between the requesting user and each user of the network of untrusted users. For example, since the trusted connection score is proportional to the trustworthiness of the requesting user, the greater the number of connections between the requesting user and untrusted users with a history of defaulting on payments and the fewer the degrees of separation between the requesting user and each of these untrusted users, the lower the requesting user's trusted connection score.

Different connections between the requesting user and other users may be weighted differently based on information stored in association with the connections indicating different types of relationships between the requesting user and the other users. For example, a connection between the requesting user and a user of the trusted network may be weighted based on a type of connection between the users (e.g., client-agency relationships are weighted differently than corporation-conglomerate relationships) and/or based on an amount of business between the users, such that the weight is proportional to dollar amounts of previous business transactions and/or a number of previous business transactions. Additionally, connections may be weighted based on their duration. For example, if a connection between the requesting user and a user of the untrusted network has been established for 11 years and a connection between the requesting user and a user of the trusted network was established a more recent three years ago, the former is weighted more heavily than the latter. Connections also may be weighted based on interactions between connected users. In the previous example, if the requesting user and the user of the untrusted network have not interacted on the online system 140 within the previous two years and the requesting user and the user of the trusted network have frequently interacted on the online system 140 within the previous two years, the connection between the requesting user and the user of the trusted network is weighted more heavily than the connection between the requesting user and the user of the untrusted network.

In some embodiments, each of multiple connections between the requesting user and the same user of the trusted network is used to determine the trusted connection score. For example, if a direct connection and three indirect connections exist between the requesting user and a user of the trusted network, each connection is used to determine the trusted connection score for the requesting user, such that the direct connection is weighted more heavily than each of the three indirect connections. In other embodiments, if multiple connections exist between the requesting user and the same user of the trusted network, only a subset of the connections may be used to determine the trusted connection score for the requesting user. For example, only the connection with the fewest degrees of separation between the requesting user and a user of the trusted network (e.g., the direct connection in the previous example) may be used to determine the trusted connection score for the requesting user.

Based on the trusted connection score determined for the requesting user, the online system may determine whether to grant or deny the requesting user's request to create a new advertising account. For example, if the trusted connection score for the requesting user is at least a threshold score, indicating at least a threshold measure of trustworthiness associated with the requesting user, the online system may grant the requesting user's request to create an advertising account and allocate an amount of credit to the account. As an additional example, if the trusted connection score determined for the requesting user in this example is less than the threshold score, indicating less than the threshold measure of trustworthiness associated with the requesting user, the online system may not permit the requesting user to create the advertising account. If the online system grants the requesting user's request to create an advertising account, the amount of credit allocated to the new advertising account may be a default amount. For example, every new advertising account may be associated with a default of $5,000 in credit. Alternatively, the amount of credit allocated to the new advertising account may be specified by the requesting user (e.g., in the request received from the requesting user). The amount of credit allocated to a new advertising account also may be proportional to the trusted connection score determined for the requesting user.

In some embodiments, the online system may allow the requesting user to request to create multiple advertising accounts. For example, the online system may allow the requesting user to specify a number of advertising accounts in their request to create the accounts. In such embodiments, the online system may determine whether to allocate the requested number of advertising accounts based on the trusted connection score for the requesting user, such that the number of advertising accounts that may be allocated is proportional to the trusted connection score. If the online system determines that the requesting user's request to create a specified number of advertising accounts should not be granted, the online system may deny the request, but offer to allow the requesting user to create fewer advertising accounts. For example, different ranges of trusted connection scores may be associated with different numbers of advertising accounts, such that the number of advertising accounts is proportional to the ranges of trusted connection scores. In this example, if the trusted connection score determined for the requesting user is less than a threshold score required for the online system to create the number of advertising accounts being requested by the requesting user, the online system may deny the request, but offer to allow the requesting user to create a smaller number of advertising accounts that corresponds to a range of trusted connection scores that includes the requesting user's trusted connection score.

In one embodiment, the number of advertising accounts allocated to the requesting user is inversely proportional to the amount of credit allocated to each advertising account. For example, the online system may allocate various numbers of advertising accounts to the requesting user, as long as the total amount of credit allocated to the requesting user is equal to or less than a maximum amount. In this example, the online system may allocate one advertising account to the requesting user that is allocated $1,000 in credit, two advertising accounts that are each allocated $500 in credit, three advertising accounts that are each allocated $333 in credit, etc.

The online system also may use the trusted connection score determined for the requesting user to determine whether to allocate an amount of credit to an account associated with the requesting user (e.g., a newly-created advertising account or an existing advertising account). For example, different amounts of credit may be associated with different ranges of trusted connection scores, such that the greater the amount of credit being requested by the requesting user, the higher the trusted connection score required in order for the online system to grant the request. If the online system determines that the requesting user's request for an amount of credit should not be granted, the online system may deny the request, but offer a lesser amount of credit to allocate to the requesting user. In the previous example, if the trusted connection score determined for the requesting user is less than a threshold score required for the online system to allocate the amount of credit being requested, the online system may deny the request, but offer the requesting user a lesser amount of credit for which the requesting user's trusted connection score qualifies.

In various embodiments, the online system may use the trusted connection score determined for the requesting user for other purposes as well. In one embodiment, the online system uses the trusted connection score to determine whether advertisement requests received from the requesting user should be manually reviewed. For example, if the trusted connection score determined for the requesting user is within a range of scores, the online system may permit the requesting user to create a new advertising account and allocate a specified amount of credit to the account, but may require advertisement requests received from the requesting user to be manually reviewed for compliance with advertising policies before presenting them to users of the online system. In some embodiments, the online system also may use the trusted connection score for a requesting user to determine whether to add the requesting user to the trusted network. The requesting user may be added to the trusted network based on their trusted connection score, based on an effect of their trusted connection score, or based on some combination of attributes associated with the requesting user. For example, the requesting user may be added to the trusted network if the amount of credit allocated to the requesting user is at least a threshold amount or the number of advertising accounts allocated to the requesting user reaches a maximum number permitted by the online system. As an additional example, the requesting user may be added to the trusted network if their trusted connection score is at least a threshold value and the online system has maintained an advertising account for the requesting user for at least 10 years.

The online system may generate a notification that is sent to the requesting user notifying them about whether their request to create one or more advertising accounts and/or whether their request to allocate an amount of credit to an advertising account associated with their user profile was granted or denied. For example, if the trusted connection score determined for the requesting user is at least a threshold score, the online system may send a notification to the requesting user that indicates that their request has been granted and specifies a number of advertising accounts allocated to the requesting user, an amount of credit allocated to each of the accounts, etc. As an additional example, if the trusted connection score determined for the requesting user is less than the threshold score, the online system may send a notification to the requesting user that indicates that their request has been denied and includes details about why the request was denied (e.g., a maximum number of advertising accounts that may be associated with their user profile has been reached, a number of previous payments on which the requesting user has defaulted, etc.).

In some embodiments, the notification may permit the requesting user to provide one or more inputs related to the notification. For example, if the requesting user has requested to create at least one advertising account, the notification may inform the requesting user that they are permitted to create up to a maximum number of advertising accounts, in which the maximum number of advertising accounts is proportional to their trusted connection score. In this example, the notification may include an input area that allows the requesting user to specify a number of advertising accounts to create. As an additional example, the notification may include an input area that allows the requesting user to create a name associated with a newly created advertising account or to associate one or more advertisements or advertising campaigns with the advertising account. The notification also may include one or more interactive elements that allow the requesting user to compare multiple advertising accounts and credit options that may be allocated to the requesting user. For example, if the notification informs the requesting user that their request to create three advertising accounts has been granted and that a maximum amount of $3,000 in credit may be allocated to the accounts, the notification may include radio buttons, drop-down menus, slider bars, etc. that allow the requesting user to select an amount of credit to allocate to each account. In this example, if the requesting user specifies amounts of credit to allocate to two accounts, the amount of credit allocated to the other account is automatically adjusted so that the total amount allocated to all three accounts does not exceed $3000.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for determining whether to permit a requesting user of an online system to create an advertising account associated with a user profile associated with the requesting user, in accordance with an embodiment.

FIG. 4 is an example of social graph used to identify connections between a requesting user of an online system and one or more users of a network of trusted users of the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

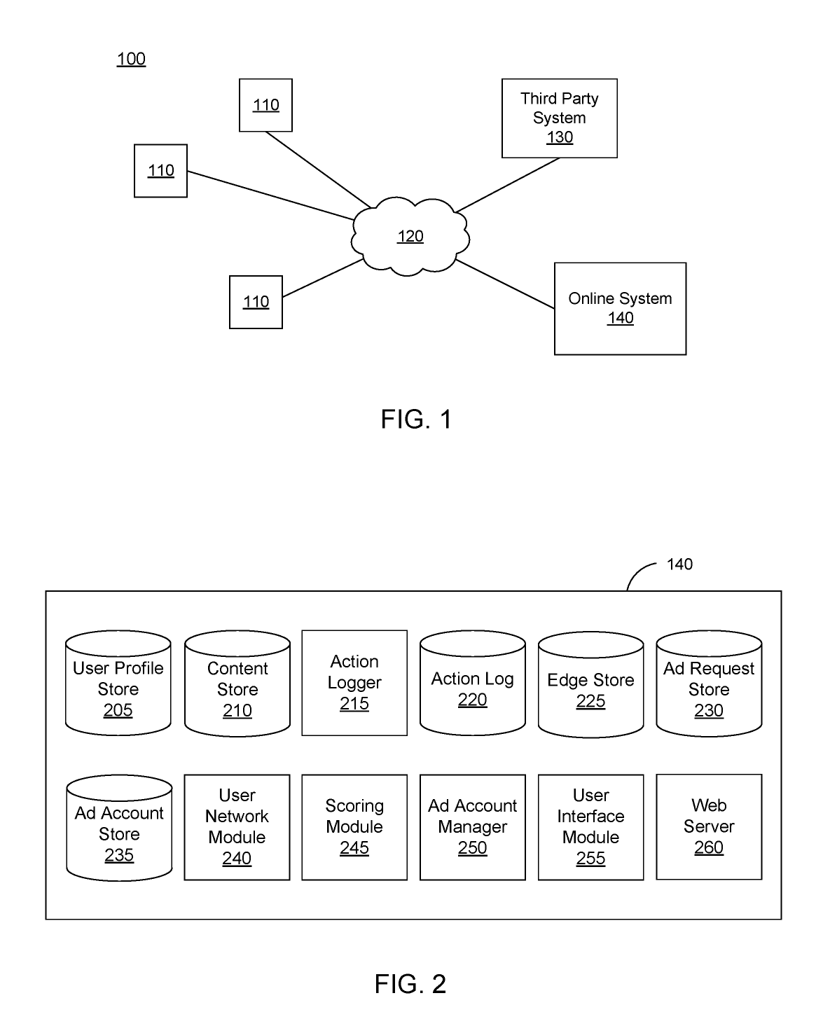

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an ad request store 230, an ad account store 235, a user network module 240, a scoring module 245, an ad account manager 250, a user interface module 255, and a web server 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on the third party system 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the online system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In some embodiments, the edge store 225 stores information describing one or more connections between the requesting user and users of the trusted network. Connections between users of the online system 140 may be stored in a graph (e.g., a social graph) maintained by the online system 140 and stored in the edge store 225. The social graph may include several nodes, in which each node corresponds to an object maintained by the online system 140, (e.g., a user of the online system 140). The social graph also may include edges that connect the nodes, in which each edge corresponds to a connection between two or more objects. A connection between two objects maintained by the online system 140 may be characterized based on the degrees of separation between them. The number of degrees separating two objects is equal to the number of edges required to connect the objects in the social graph. For example, one degree of separation separates users with a direct connection to each other. As an additional example, more than one degree of separation exists between users with an indirect connection (e.g., two degrees separate users who are both connected to a mutual friend). Multiple connections may exist between two objects maintained by the online system 140. For example, two users may be connected via a direct connection and multiple indirect connections, such that in a social graph, multiple paths exist that connect the nodes representing the users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if a user interacts with the advertisement in the ad request when presented to the user, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 for presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users associated with user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria also may specify interactions between a user and objects performed external to the online system 140, such as on a third party system 130. For example, targeting criteria identifies users who have performed a particular action, such as having sent a message to another user, having used an application, having joined or left a group, having joined an event, having generated an event description, having purchased or reviewed a product or service using an online marketplace, having requested information from a third party system 130, having installed an application, or having performed any other suitable action. Including actions in targeting criteria allows advertisers to further refine users eligible to be presented with advertisement content from an ad request. As another example, targeting criteria identifies users having a connection to another user or object or having a particular type of connection to another user or object.

The advertisement account store (“ad account store”) 235 stores historical information describing advertising accounts and/or amounts of credit associated with user profiles maintained by the online system 140. Multiple advertising accounts with different amounts of credit may be associated with a particular user profile. Information describing an advertising account associated with a user profile may include general information (e.g., the date the account was created, the amount of credit initially allocated to the account, dates and amounts of increases in credit allocated to the account, etc.), account activity (e.g., frequency and amounts of charges), information describing invoices for ad charges (e.g., balances owed on the account, descriptions of advertising services rendered, etc.), payment history (e.g., dates and amounts of payments made on the account, form of payment, whether payments were late or made in full, etc.), and any other suitable information associated with the advertising account.

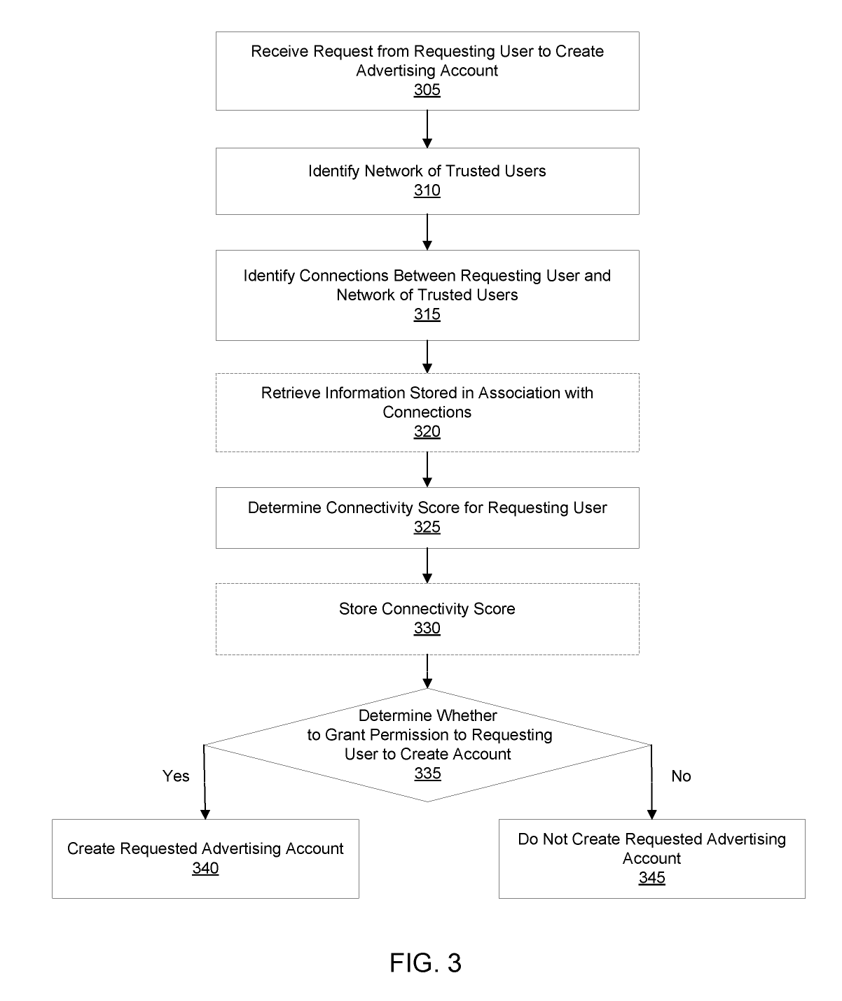

The ad account store 235 also may store information describing requests submitted by online system users to create advertising accounts and/or to allocate an amount of credit to an advertising account. For example, the ad account store 235 may store dates that a user requested to create an advertising account, dates that the user requested that the online system 140 allocate more credit to an existing advertising account, and the outcomes of the requests. In embodiments in which the online system 140 determines a score or other value that indicates a measure of trustworthiness of a user (e.g., a trusted connection score), the score or value may be stored in the ad account store 235 in association with information identifying the user. The functionality of the ad account store 235 is further described below in conjunction with FIG. 3.

The user network module 240 may identify users of the trusted network based on historical information associated with each of the trusted users indicating at least a threshold measure of credit-worthiness (e.g., from the ad account store 235 and/or user profile store 205). For example, an advertiser or advertising agency is considered a trusted user if it has at least three advertising accounts with the online system 140, actively uses the accounts every month, has spent at least $10,000 on advertising each year for at least the previous eight years, and has never defaulted on a payment to the online system 140 in exchange for advertising services during those eight years. In some embodiments, the historical information used to identify users of the trusted network may correspond to a frequency or seasonality of advertisement purchases made by the users. For example, if a trusted user primarily purchases advertisements for snow tires, rather than using a total amount spent by the trusted user to determine the credit-worthiness of the user, the user network module 240 determines the credit-worthiness of the user based on the user's average monthly advertisement purchases during months in the winter and late fall.

In some embodiments, when identifying users of the trusted network, the user network module 240 discounts historical spending information associated with the users by an amount that the online system 140 has not yet collected or by an amount charged by the online system 140 that may be subject to reversal (e.g., chargeback of a disputed amount). For example, a user is included in the trusted network if the total amount the user spent on advertising in the previous year, when adjusted by any pending payments towards the total amount, is at least a threshold amount. The user network module 240 may identify amounts not yet collected by the online system 140 and/or amounts that may be subject to reversal based on geographic information associated with users and/or payment information provided by the users. For example, different policies may apply to users located in different geographic locations, such that the timeframe within which a charge may be disputed may vary for different users based on their geographic location. As an additional example, recent payments made by credit cards may be subject to reversal while older payments made by credit cards and by withdrawals from a bank account are less likely to be subject to reversal.

The user network module 240 also may identify users of the trusted network based on information stored in the edge store 225 indicating connections between the users of the trusted network. For example, once the user network module 240 has identified a trusted user of the online system 140, the user network module 240 may retrieve information from the edge store 225 describing connections between the trusted user and additional users of the online system 140. In this example, the user network module 240 user network module 240 may then determine whether each additional user to which the trusted user is connected is also a trusted user. Additional users connected to the trusted user who are determined to be trusted users are also identified as part of the trusted network while additional users connected to the trusted user who are not determined to be trusted users are not identified as part of the trusted network.

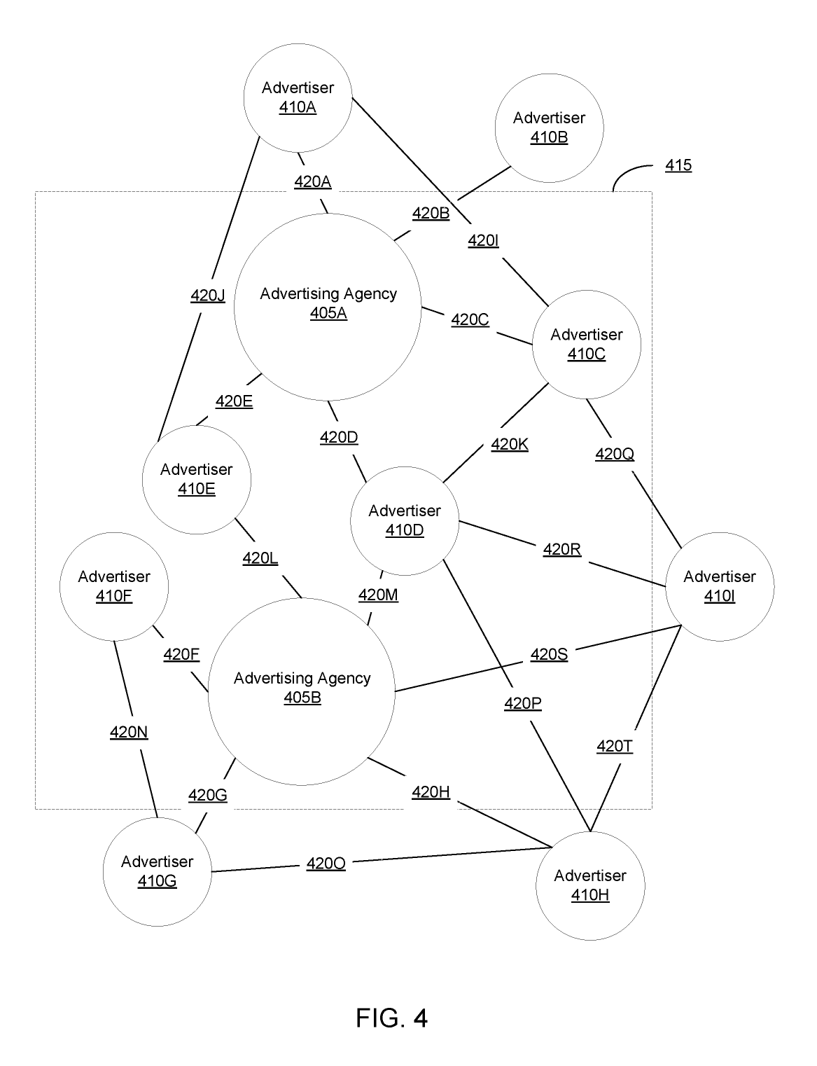

In some embodiments, the user network module 240 also may use the trusted connection score for a requesting user to determine whether to add the requesting user to the trusted network. The requesting user may be added to the trusted network based on their trusted connection score, based on an effect of their trusted connection score, or based on some combination of attributes associated with the requesting user. For example, the requesting user may be added to the trusted network if the amount of credit allocated to the requesting user is at least a threshold amount or the number of advertising accounts allocated to the requesting user reaches a maximum number permitted by the online system 140. As an additional example, the requesting user may be added to the trusted network if their trusted connection score is at least a threshold value and the online system 140 has maintained an advertising account for the requesting user for at least 10 years. The functionality of the user network module 240 is further described below in conjunction with FIGS. 3 and 4.

The scoring module 245 identifies connections between a requesting user and one or more users of the trusted network. For example, the scoring module 245 identifies connections between the requesting user and a user of the trusted network by accessing information stored in the edge store 225 (e.g., a social graph maintained by the online system 140) to determine whether a connection exists between the users and if so, the degrees of separation between the users. Once the scoring module 245 has identified connections between the requesting user and one or more users of the trusted network, the scoring module 245 may retrieve information stored in association with the connections. Examples of types of information stored in association with a connection between the requesting user and a user of the trusted network include an age of the connection, information describing a type of connection between the users, such as business relationships (e.g., co-workers, client-agency relationships) and personal relationships (e.g., friendships and familial relationships), information describing transactions between the users (e.g., content shared by the users, messages exchanged between the users, a number/dollar amount of business transactions between the users, etc.), and any other suitable types of information describing the connection between the users.

The scoring module 245 determines a trusted connection score for the requesting user, in which the trusted connection score indicates a measure of trustworthiness of the requesting user. Therefore, the more connected the requesting user is to a network of trusted users who are each associated with at least a threshold measure of trustworthiness, the higher the trusted connection score for the requesting user and thus, the greater the trustworthiness of the requesting user. The trusted connection score for the requesting user may be determined based on the number of connections the requesting user has to the trusted network. For example, the trusted connection score may be proportional to the number of different paths connecting the requesting user to users of the trusted network in a social graph maintained by the online system 140. The trusted connection score for the requesting user also may be determined based on the degrees of separation between the requesting user and each user of the trusted network to which the requesting user is connected. For example, the trusted connection score is inversely proportional to the degrees of separation between the requesting user and each user of the trusted network.

In various embodiments, the scoring module 245 may use additional types of information to determine the trusted connection score for the requesting user. In one embodiment, in addition to the requesting user's connections to the trusted network, the scoring module 245 also determines the trusted connection score based on the requesting user's connections to a network of untrusted users (i.e., a network of users of the online system 140 having less than a threshold measure of trustworthiness). For example, since the trusted connection score is proportional to the trustworthiness of the requesting user, the greater the number of connections between the requesting user and untrusted users with a history of defaulting on payments and the fewer the degrees of separation between the requesting user and each of these untrusted users, the lower the requesting user's trusted connection score.

Different connections between the requesting user and other users may be weighted differently when determining the trusted connection score for the requesting user based on information stored in association with the connections between the users. For example, a connection between the requesting user and a user of the trusted network may be weighted based on a type of connection between the users (e.g., client-agency relationships are weighted differently than corporation-conglomerate relationships, which are both weighted differently than friendships). As an additional example, the connection may be weighted based on an amount of business between the connected users, such that the weight is proportional to dollar amounts of previous business transactions and/or a number or frequency of previous business transactions between the users. As yet another example, connections may be weighted based on their duration, such that if a connection between the requesting user and a user of the untrusted network has been established for two years and a connection between the requesting user and a user of the trusted network has been established for 20 years, the latter is weighted more heavily than the former and in proportion to the ages of the connections. Connections also may be weighted based on interactions between connected users. In the previous example, if the requesting user and the user of the trusted network have not interacted on the online system 140 within the previous year and the requesting user and the user of the untrusted network have frequently interacted on the online system 140 within the previous year, the connection between the requesting user and the user of the untrusted network is weighted more heavily than the connection between the requesting user and the user of the trusted network.

In some embodiments, multiple connections between the requesting user and a user of the trusted network may be used to determine the trusted connection score for the requesting user. For example, if a direct connection and three indirect connections exist between the requesting user and a user of the trusted network, each connection is used to determine the trusted connection score for the requesting user and the direct connection may be weighted more heavily than each of the three indirect connections. In other embodiments, if multiple connections exist between the requesting user and a user of the trusted network, only a subset of the connections may be used to determine the trusted connection score for the requesting user. For example, only the connection with the fewest degrees of separation between the requesting user and a user of the trusted network (e.g., the direct connection in the previous example) may be used to determine the trusted connection score for the requesting user. The functionality of the scoring module 245 is further described below in conjunction with FIGS. 3 and 4.

The advertising account manager (“ad account manager”) 245 determines whether to grant or deny permission to a requesting user to create an advertising account. The ad account manager 250 determines whether to grant or deny permission to the requesting user to create the advertising account based on the trusted connection score determined for the requesting user by the scoring module 245. For example, if the trusted connection score for the requesting user is at least a threshold score, indicating at least a threshold measure of trustworthiness associated with the requesting user, the ad account manager 250 may grant the requesting user's request to create an advertising account. However, if the trusted connection score determined for the requesting user in this example is less than the threshold score, indicating less than the threshold measure of trustworthiness associated with the requesting user, the ad account manager 250 may not permit the requesting user to create the advertising account.

In some embodiments, the ad account manager 250 may determine whether to grant or deny permission to the requesting user to create multiple advertising accounts. For example, the online system 140 may allow the requesting user to specify a number of advertising accounts in their request to create the advertising accounts. In such embodiments, the ad account manager 250 may determine whether to allocate the requested number of advertising accounts to the requesting user based on the trusted connection score for the requesting user, such that the number of advertising accounts that may be allocated is proportional to the trusted connection score. If the ad account manager 250 determines that the requesting user's request to create a specified number of advertising accounts should not be granted, the ad account manager 250 may deny the request, but offer to allow the requesting user to create fewer advertising accounts. For example, different ranges of trusted connection scores may be associated with different numbers of advertising accounts, such that the number of advertising accounts is proportional to the ranges of trusted connection scores. In this example, if the trusted connection score determined for the requesting user is less than a threshold score required for the ad account manager 250 to create the number of advertising accounts being requested, the ad account manager 250 may deny the request, but offer to allow the requesting user to create a smaller number of advertising accounts for which the trusted connection score qualifies.

The number of advertising accounts allocated to the requesting user may be inversely proportional to the amount of credit allocated to each advertising account. In one embodiment, the ad account manager 250 may allocate various numbers of advertising accounts to the requesting user, as long as the total amount of credit allocated to the requesting user is equal to or less than a maximum amount. For example, the ad account manager 250 may allocate one advertising account to the requesting user that is allocated $2,000 in credit, two advertising accounts that are each allocated $1,000 in credit, three advertising accounts that are each allocated $666 in credit, etc.

The ad account manager 250 may determine whether to grant or deny a requesting user's request to allocate an amount of credit to the requesting user. The ad account manager 250 may determine whether to allocate an amount of credit to an account associated with the requesting user (e.g., a newly-created advertising account or an existing advertising account) based on the trusted connection score determined for the requesting user. For example, different amounts of credit may be associated with different ranges of trusted connection scores, such that the greater the amount of credit being requested by the requesting user, the higher the trusted connection score required in order for the online system 140 to grant the request. If the ad account manager 250 determines that the requesting user's request for an amount of credit should not be granted, the ad account manager 250 may deny the request, but offer a lesser amount of credit to allocate to the requesting user. In the previous example, if the trusted connection score determined for the requesting user is less than a threshold score required for the ad account manager 250 to allocate the amount of credit being requested, the ad account manager 250 may deny the request, but offer the requesting user a lesser amount of credit for which the requesting user's trusted connection score qualifies.

If the ad account manager 250 grants the requesting user's request to create a new advertising account, the ad account manager 250 allocates the new advertising account to the requesting user that is associated with the requesting user's user profile. The ad account manager 250 also may allocate an amount of credit to a new or existing advertising account. If the ad account manager 250 grants the requesting user's request to create a new advertising account, the amount of credit allocated to the new advertising account may be a default amount. For example, every new advertising account may be associated with a default of $5,000 in credit. Alternatively, the amount of credit allocated to a new or existing advertising account may be specified by the requesting user (e.g., in the request received from the requesting user). As another alternative, the amount of credit allocated to a new or existing advertising account may be determined by the ad account manager 250 (e.g., based on the requesting user's trusted connection score, such that the amount of credit allocated is proportional to the trusted connection score).

In one embodiment, the ad account manager 250 uses the trusted connection score to determine whether advertisement requests received from the requesting user should be manually reviewed. For example, if the trusted connection score determined for the requesting user is within a range of scores, the ad account manager 250 may permit the requesting user to create a new advertising account and allocate a specified amount of credit to the account, but may require advertisement requests received from the requesting user to be manually reviewed for compliance with advertising policies before presenting them to users of the online system 140. The functionality of the ad account manager 250 is further described below in conjunction with FIGS. 3 and 4.

The user interface module 255 may generate a notification that is sent to the requesting user notifying the requesting user whether their request to create one or more advertising accounts and/or to allocate an amount of credit to an advertising account associated with their user profile was granted or denied. For example, if the trusted connection score determined for the requesting user is at least a threshold score, the user interface module 255 may generate a notification that is sent to the requesting user that indicates that their request has been granted and specifies a number of advertising accounts allocated to the requesting user, an amount of credit allocated to each of the accounts, etc. As an additional example, if the trusted connection score determined for the requesting user is less than the threshold score, the user interface module 255 may generate a notification that is sent to the requesting user that indicates that their request has been denied and includes details about why the request was denied (e.g., a maximum number of advertising accounts that may be associated with their user profile has been reached, a number of previous payments on which the requesting user has defaulted, etc.).

In some embodiments, the notification may permit the requesting user to provide one or more inputs related to the notification. For example, if the requesting user has requested to create at least one advertising account, the notification may inform the requesting user that they are permitted to create up to a maximum number of advertising accounts, in which the maximum number of advertising accounts is proportional to their trusted connection score. In this example, the notification may include an input area that allows the requesting user to specify a number of advertising accounts to create. As an additional example, the notification may include an input area that allows the requesting user to create a name associated with a newly created advertising account or to associate one or more advertisements or advertising campaigns with the advertising account.

The notification also may include one or more interactive elements that allow the requesting user to compare multiple advertising accounts and credit options that may be allocated to the requesting user. For example, if the notification informs the requesting user that their request to create three advertising accounts has been granted and that a maximum amount of $3,000 in credit may be allocated to the accounts, the notification may include radio buttons, drop-down menus, slider bars, etc. that allow the requesting user to select an amount of credit to allocate to each account. In this example, if the requesting user specifies amounts of credit to allocate to two accounts, the amount of credit allocated to the other account is automatically adjusted so that the total amount allocated to all three accounts does not exceed $3,000. The functionality of the user interface module 255 is further described below in conjunction with FIG. 3.

The web server 260 links the online system 140 via the network 120 to the one or more client devices 110, as well as to the third party system 130 and/or one or more third party systems. The web server 260 serves web pages, as well as other content, such as JAVA®, FLASH®, XML and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210 or to create an advertising account associated with a user profile of the user. Additionally, the web server 260 may provide application programming interface (API) functionality to send data directly to native client device operating systems, such as IOS®, ANDROID™, WEBOS® or BlackberryOS.

### Determining Whether to Allocate Credit to a User for Advertising Services

FIG. 3 is a flow chart of a method for determining whether to permit a requesting user of an online system to create an advertising account associated with a user profile associated with the requesting user, according to one embodiment. In other embodiments, the method may include different and/or additional steps than those shown in FIG. 3. Additionally, steps of the method may be performed in a different order than the order described in conjunction with FIG. 3.

The online system 140 receives 305 (e.g., via the web server 260) a request from a requesting user to create an advertising account associated with a user profile of the requesting user. The advertising account, if created, is associated with an amount of credit extended to the requesting user for purchasing advertising services provided by the online system 140. The amount of credit may be a default amount (e.g., an amount associated with all newly-created advertising accounts), an amount specified by the requesting user (e.g., included in the request received from the requesting user), or an amount to be determined by the ad account manager 250. In various embodiments, the requesting user may specify a number of advertising accounts in their request to create the advertising account(s). In addition or alternatively, in some embodiments, the request received from the requesting user is a request to allocate an amount of credit to an advertising account associated with the requesting user (e.g., an existing advertising account).

The online system 140 identifies 310 (e.g., via the user network module 240) a trusted network of users of the online system 140. The user network module 240 may identify 310 users of the trusted network based on historical information associated with each of the trusted users indicating at least a threshold measure of credit-worthiness. The historical information may be retrieved from the ad account store 235 and/or the user profile store 205. For example, an advertiser or advertising agency is considered a trusted user if information retrieved from the ad account store 235 indicates that it has at least five advertising accounts with the online system 140, actively uses the accounts every month, has spent at least $15,000 on advertising each year for at least the previous six years, and has never defaulted on a payment to the online system 140 in exchange for advertising services during those six years. In some embodiments, the historical information used to identify 310 users of the trusted network may correspond to a frequency or seasonality of advertisement purchases made by the users. For example, if a trusted user primarily purchases advertisements for Halloween costumes, rather than using a total amount spent by the trusted user to determine the credit-worthiness of the user, the online system 140 determines the credit-worthiness of the user based on the user's average monthly advertisement purchases during months approaching and including Halloween (e.g., August, September, and October).

When identifying 310 users of the trusted network, the user network module 240 may discount historical spending information associated with the users by an amount that the online system 140 has not yet collected or by an amount charged by the online system 140 that may be subject to reversal (e.g., chargeback of a disputed amount). For example, a user is included in the trusted network if the total amount the user spent on advertising in the previous year, when adjusted by any pending payments towards the total amount, is at least a threshold amount. The user network module 240 may identify amounts not yet collected by the online system 140 and/or amounts that may be subject to reversal based on geographic information associated with users and/or payment information provided by the users. For example, different policies may apply to users located in different geographic locations, such that the timeframe within which a charge may be disputed may vary for different users based on their geographic location. As an additional example, recent payments made by credit cards may be subject to reversal while older payments made by credit cards and by withdrawals from a bank account are less likely to be subject to reversal.

The user network module 240 also may identify 310 users of the trusted network based on information stored in the edge store 225 indicating connections between the users of the trusted network, such as a social graph maintained by the online system 140. In the example of FIG. 4, a social graph maintained by the online system 140 includes nodes corresponding to users of a trusted network of users (e.g., Advertising Agencies 405A-405B and Advertisers 410C-410F). The social graph also includes nodes corresponding to additional users (Advertisers 410A-410B and Advertisers 410G-410I) that are not included in the trusted network, where a boundary 415 separates the groups of users. The social graph also may include edges 420 that connect the nodes that each corresponds to a connection between two or more users. Once the user network module 240 has identified 310 a trusted user of the online system 140, the user network module 240 may retrieve information from the edge store 225 describing connections between the trusted user and additional users of the online system 140. The user network module 240 may then determine whether each additional user to which the trusted user is connected is also a trusted user. Additional users connected to the trusted user who are determined to be trusted users are also identified 310 as part of the trusted network while additional users connected to the trusted user who are not determined to be trusted users are not identified 310 as part of the trusted network.

Referring back to FIG. 3, the online system 140 identifies 315 (e.g., via the scoring module 245) one or more connections between the requesting user and one or more users of the trusted network. The scoring module 245 may identify 315 connections between the requesting user and a user of the trusted network by accessing a graph (e.g., a social graph) maintained by the online system 140 and stored in the edge store 225. The scoring module 245 also may identify 315 characteristics of the one or more connections between the requesting user and one or more users of the trusted network. In some embodiments, the scoring module 245 may identify 315 the degrees of separation between the requesting user and a user of the trusted network.

In some embodiments, the user network module 240 may identify 310 users of the trusted network after the scoring module 245 identifies 315 one or more connections between the requesting user and one or more additional users. For example, for each connection between the requesting user and an additional user of the online system identified 315 by the scoring module 245, the user network module 240 identifies 310 users of the trusted network, (e.g., from a social graph maintained by the online system 140) and determines whether the additional user is included in the trusted network.

The number of degrees of separation between the users may be equal to the number of edges required to connect the nodes corresponding to the users in the social graph. For example, in FIG. 4, one degree of separation separates users with a direct connection to each other, such as Advertiser 410A and Advertiser 410C since they are connected by one edge 4201, while more than one degree of separation exists between users with an indirect connection. For example, two degrees separate users who are both connected to a mutual friend, such as Advertiser 410B and Advertiser 410D, who are both connected to Advertising Agency 405A by two edges (edge 420B and edge 420D). In some embodiments, the scoring module 245 also may identify 315 multiple connections that exist between the requesting user and a user of the trusted network. For example, if the requesting user (e.g., Advertiser 410H) and a user of the trusted network (e.g., Advertiser 410D) are connected via a direct connection (e.g., edge 420P) and multiple indirect connections (e.g., via Advertising Agency 405B, via Advertiser 410I, etc.), such that in a social graph, multiple paths exist that connect the nodes representing the users, the scoring module 245 may identify 315 each of these paths.

Referring again to FIG. 3, in some embodiments, the online system 140 also may retrieve 320 (e.g., via the scoring module 245) information stored in association with connections between the requesting user and one or more users of the trusted network. For example, the scoring module 245 may retrieve 320 information stored in association with each connection between the requesting user and a user of the trusted network from the edge store 225. An example of a type of information stored in association with a connection between the requesting user and a user of the trusted network is an age of the connection (e.g., based on a date when the connection was established). An additional type of information stored in association with a connection is a description of a type of connection between the users, such as business relationships (e.g., co-workers, client-agency relationships) and personal relationships (e.g., friendships and familial relationships). Information stored in association with a connection also may include information describing interactions between the users (e.g., content shared by the users, messages exchanged between the users, a number/dollar amount of business transactions between the users, etc.). The information stored in association with a connection between the requesting user and a user of the trusted network may include any other suitable types of information describing the connection between the users.

The online system 140 determines 325 (e.g, via the scoring module 245) the trusted connection score for the requesting user. The trusted connection score for the requesting user indicates a measure of trustworthiness of the requesting user that is based at least in part on one or more connections between the requesting user and one or more users of the trusted network. The more connected the requesting user is to users of the trusted network, the higher the trusted connection score for the requesting user and thus, the greater the trustworthiness of the requesting user. The trusted connection score for the requesting user may be determined 325 based on the number of connections the requesting user has to the trusted network. For example, the trusted connection score may be proportional to the number of different paths connecting the requesting user to users of the trusted network in a social graph maintained by the online system 140. The trusted connection score for the requesting user also may be determined 325 based on the degrees of separation between the requesting user and each user of the trusted network to which the requesting user is connected. For example, the trusted connection score is inversely proportional to the degrees of separation between the requesting user and each user of the trusted network.

In various embodiments, the online system 140 may use additional types of information to determine 325 the trusted connection score for the requesting user. In one embodiment, the online system 140 also determines 325 the trusted connection score based on the requesting user's connections to a network of untrusted users (i.e., a network of users of the online system 140 having less than a threshold measure of trustworthiness). For example, since the trusted connection score is proportional to the trustworthiness of the requesting user, the greater the number of connections between the requesting user and untrusted users with a history of defaulting on payments and the fewer the degrees of separation between the requesting user and each of these untrusted users, the lower the requesting user's trusted connection score.

Different connections between the requesting user and both trusted and untrusted users may be weighted differently based on information stored in association with the connections between the users. For example, a connection between the requesting user and a user of the trusted network may be weighted based on a type of relationship between the users, where a relationship that indicates a high level of trust between the users is weighted more heavily than a relationship that indicates a lower level of trust between the users (e.g., a relationship between a client and an agency is weighted more heavily than a relationship between former classmates). As an additional example, the connection may be weighted based on an amount of business between the connected users, such that the weight is proportional to dollar amounts of previous business transactions and/or a number or frequency of previous business transactions between the users. As yet another example, connections may be weighted based on their duration, such that if a connection between the requesting user and a user of the untrusted network has been established for two years and a connection between the requesting user and a user of the trusted network has been established for 20 years, the latter is weighted more heavily than the former and in proportion to the ages of the connections. Connections also may be weighted based on interactions between connected users. In the previous example, if the requesting user and the user of the trusted network have not interacted on the online system 140 within the previous two years and the requesting user and the user of the untrusted network have frequently interacted on the online system 140 within the previous two years, the connection between the requesting user and the user of the untrusted network is weighted more heavily than the connection between the requesting user and the user of the trusted network.

In some embodiments, multiple connections between the requesting user and a user of the trusted network may be used to determine 325 the trusted connection score for the requesting user. For example, if a direct connection and three indirect connections exist between the requesting user and a user of the trusted network, each connection is used to determine 325 the trusted connection score for the requesting user and the direct connection may be weighted more heavily than each of the three indirect connections. In other embodiments, if multiple connections exist between the requesting user and a user of the trusted network, only a subset of the connections may be used to determine 325 the trusted connection score for the requesting user. For example, only the connection with the fewest degrees of separation between the requesting user and a user of the trusted network (e.g., the direct connection in the previous example) may be used to determine 325 the trusted connection score for the requesting user.

In some embodiments, the trusted connection score for the requesting user is stored 330 by the online system 140. For example, the trusted connection score for the requesting user may be stored 330 in the ad account store 235 in association with a user profile of the requesting user and a date that the trusted connection score was determined 325. In some embodiments, only the most current trusted connection score is stored 330 for the requesting user (e.g., by updating the previous trusted connection score with a new one) while in other embodiments, all trusted connection scores determined 325 for the requesting user are stored (e.g., in a growing log of historical trusted connection scores).

The online system 140 may determine 335 (e.g., via the ad account manager 250) whether to grant or deny permission to the requesting user to create the advertising account associated with the user profile of the requesting user based on the trusted connection score determined 325 for the requesting user. The online system 140 creates 340 (e.g., using the ad account manager 250) the requested advertising account associated with the user profile of the requesting user in response to the trusted connection score for the requesting user exceeding a threshold score. The ad account manager 250 creates 340 the requested advertising account by allocating the new advertising account to the requesting user, such that the account is associated with the requesting user's user profile. In embodiments in which the request received 305 from the requesting user is a request to allocate an amount of credit to an advertising account associated with the requesting user, the ad account manager 250 may allocate the requested amount of credit to the advertising account in response to the trusted connection score for the requesting user exceeding the threshold score. Alternatively, in response to the trusted connection score for the requesting user failing to exceed the threshold score, the ad account manager 250 denies the requesting user's request and does not create 345 the advertising account or to allocate the amount of credit to an advertising account associated with the requesting user.

In embodiments in which the online system 140 allows the requesting user to request to create multiple advertising accounts, the ad account manager 250 may determine 335 whether to grant or deny permission to the requesting user to create the accounts. For example, the ad account manager 250 may determine 335 whether to allocate the requested number of advertising accounts to the requesting user based on the trusted connection score for the requesting user, such that the number of advertising accounts that may be allocated to the requesting user is proportional to the trusted connection score. If the ad account manager 250 determines 335 that the requesting user's request to create a specified number of advertising accounts should not be granted, the ad account manager 250 may deny the request, but offer to allow the requesting user to create fewer advertising accounts. For example, different ranges of trusted connection scores may be associated with different numbers of advertising accounts, such that the number of advertising accounts is proportional to the ranges of trusted connection scores. In this example, if the trusted connection score determined 325 for the requesting user is less than a threshold score required for the ad account manager 250 to create the number of advertising accounts being requested, the ad account manager 250 may deny the request, but offer to allow the requesting user to create a smaller number of advertising accounts for which the requesting user's trusted connection score qualifies.

In embodiments in which the ad account manager 250 creates 340 a new advertising account associated with the user profile of the requesting user, the ad account manager 250 also may determine an amount of credit to allocate to the new advertising account. The amount of credit allocated to a new advertising account may be a default amount. For example, every new advertising account may be associated with a default of $5,000 in credit. Alternatively, the amount of credit allocated to a new advertising account may be specified by the requesting user (e.g., in the request received from the requesting user) and automatically allocated to the advertising account upon approval of the request by the ad account manager 250. As another alternative, the amount of credit allocated to a new advertising account may be determined by the ad account manager 250. For example, the amount of credit allocated to an advertising account is proportional to the requesting user's trusted connection score.

In embodiments in which the requesting user is permitted to create multiple advertising accounts, the number of advertising accounts that may be allocated to the requesting user may be inversely proportional to the amount of credit allocated to each advertising account. For example, the ad account manager 250 may allocate various numbers of advertising accounts to the requesting user, as long as the total amount of credit allocated to the requesting user is equal to or less than a maximum amount. In this example, the ad account manager 250 may allocate one advertising account to the requesting user that is allocated $10,000 in credit, two advertising accounts that are each allocated $5,000 in credit, three advertising accounts that are each allocated $3,333 in credit, etc.

Additionally or alternatively, if the requesting user has requested that the online system 140 allocate an amount of credit to an advertising account associated with their user profile (e.g., a newly-created advertising account or an existing advertising account), the ad account manager 250 may determine 335 whether to grant or deny the request based on their trusted connection score. For example, different amounts of credit may be associated with different ranges of trusted connection scores, such that the greater the amount of credit being requested by the requesting user, the higher the trusted connection score required in order for the ad account manager 250 to grant the request. If the ad account manager 250 determines 335 that the requesting user's request for an amount of credit should not be granted, the ad account manager 250 may deny the request, but offer a lesser amount of credit to allocate to the requesting user. In the previous example, if the trusted connection score determined 325 for the requesting user is less than a threshold score required for the ad account manager 250 to allocate the amount of credit being requested by the requesting user, the ad account manager 250 may deny the request, but offer the requesting user a lesser amount of credit for which the requesting user's trusted connection score qualifies.

In some embodiments, the ad account manager 250 also may determine whether to manually review advertisement requests received from the requesting user based on the trusted connection score determined for the requesting user. For example, if the trusted connection score determined for the requesting user is within a certain range of scores, the ad account manager 250 may permit the requesting user to create a new advertising account and allocate a specified amount of credit to the account, but may require advertisement requests received from the requesting user to be manually reviewed for compliance with advertising policies before presenting them to users of the online system 140.

In some embodiments, the user interface module 255 generates a notification that is sent to the requesting user notifying them if the advertising account was created. The notification also may or alternatively notify the requesting user whether their request to allocate an amount of credit to an advertising account associated with their user profile was granted or denied. For example, if the trusted connection score determined 325 for the requesting user is at least a threshold score, the user interface module 255 may generate a notification for the requesting user that indicates that their request has been granted and specifies a number of advertising accounts allocated to the requesting user, an amount of credit allocated to each of the allocated accounts, etc. As an additional example, if the trusted connection score determined 325 for the requesting user is less than the threshold score, the user interface module 255 may generate a notification for the requesting user that indicates that their request has been denied and includes details about why the request was denied (e.g., a maximum number of advertising accounts associated with their user profile has been reached, a number of previous payments on which the requesting user has defaulted, etc.).

In some embodiments, the notification may permit the requesting user to provide one or more inputs related to the notification. For example, if the requesting user has requested to create at least one advertising account, the notification may inform the requesting user that they are permitted to create up to a maximum number of advertising accounts, in which the maximum number of advertising accounts is proportional to their trusted connection score. In this example, the notification may include an input area that allows the requesting user to specify a number of advertising accounts to allocate. As an additional example, the notification may include an input area that allows the requesting user to create a name associated with a newly created advertising account or to associate one or more advertisements or advertising campaigns with the advertising account.

The notification also may include one or more interactive elements that allow the requesting user to compare multiple advertising accounts and credit options that may be allocated to the requesting user. For example, if the notification informs the requesting user that their request to create three advertising accounts has been granted and that a maximum amount of $3,000 in credit may be allocated to the accounts, the notification may include radio buttons, drop-down menus, slider bars, etc. that allow the requesting user to select an amount of credit to allocate to each account. In this example, if the requesting user specifies amounts of credit to allocate to two accounts, the amount of credit allocated to the other account is automatically adjusted so that the total amount allocated to all three accounts does not exceed $3000. The notification may be sent to the requesting user (e.g., in a display area of a client device 110 associated with the requesting user).

The user network module 240 may determine whether to include the requesting user in the trusted network. In some embodiments, the user network module 240 determines whether to add the requesting user to the trusted network based on the trusted connection score determined 325 for the requesting user, based on an effect of their trusted connection score, or based on some combination of attributes associated with the requesting user. For example, the requesting user may be added to the trusted network if the amount of credit allocated to the requesting user is at least a threshold amount or if the number of advertising accounts allocated to the requesting user reaches a maximum number permitted by the online system 140 to be associated with each user profile. As an additional example, the requesting user may be added to the trusted network if their trusted connection score is at least a threshold value and the online system 140 has maintained an advertising account for the requesting user for at least 10 years.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, from a requesting user of an online system, a request to create an advertising account associated with a user profile of the requesting user maintained by the online system, the advertising account associated with an amount of credit extended to the requesting user for purchasing advertising services provided by the online system;
identifying a network of trusted users of the online system, each trusted user of the network of trusted users associated with at least a threshold measure of trustworthiness;
identifying one or more connections between the requesting user and one or more trusted users of the network of trusted users of the online system;
determining a trusted connection score for the requesting user, the trusted connection score indicating a measure of trustworthiness of the requesting user based at least in part on the one or more connections between the requesting user and one or more of the trusted users of the network of trusted users of the online system; and
in response to the trusted connection score for the requesting user exceeding a threshold trusted connection score, creating the requested advertising account associated with the user profile of the requesting user.

2. The method of claim 1, wherein determining the trusted connection score for the requesting user comprises:
accessing a graph maintained by the online system, the graph comprising a plurality of nodes and one or more edges, wherein each node corresponds to an object maintained by the online system, and each edge corresponds to a connection between two or more objects;
for each of the one or more trusted users of the network of trusted users of the online system to which the requesting user is connected:
identifying in the graph a first node corresponding to the requesting user and a second node corresponding to a trusted user of the one or more trusted users of the network of trusted users;
determining a number of different paths connecting the first node and the second node, each path comprising at least the first node, the second node, and an edge; and
determining a number of edges required to connect the first node and the second node; and
determining the trusted connection score for the requesting user based at least in part on the number of different paths connecting the first node and the second node and the number of edges required to connect the first node and the second node for each of the one or more trusted users of the network of trusted users of the online system to which the requesting user is connected.

3. The method of claim 1, wherein determining the trusted connection score for the requesting user comprises:
retrieving information stored in association with a connection between the requesting user and each of the one or more trusted users of the network of trusted users;
associating a weight with the connection between the requesting user and each of the one or more trusted users of the network of trusted users based at least in part on the information stored in association with the connection; and
determining the trusted connection score for the requesting user based at least in part on the weights.

4. The method of claim 3, wherein the information stored in association with the connection between the requesting user and each of the one or more trusted users of the network of trusted users is selected from a group consisting of: information indicating a type of relationship between the requesting user and each of the one or more trusted users of the network of trusted users, a number of transactions between the requesting user and each of the one or more trusted users of the network of trusted users, a monetary amount associated with a transaction between the requesting user and each of the one or more trusted users of the network of trusted users, an amount of time elapsed since the connection was established between the requesting user and each of the one or more trusted users of the network of trusted users, and any combination thereof.

5. The method of claim 1, wherein the threshold measure of trustworthiness is based at least in part on historical information indicating credit-worthiness of each trusted user of the network of trusted users.

6. The method of claim 5, wherein the historical information indicating credit-worthiness of each trusted user of the network of trusted users includes one or more selected from a group consisting of: a number of advertising accounts associated with a user profile of each trusted user of the network of trusted users maintained by the online system, an amount of credit extended to each trusted user of the network of trusted users for advertising services provided by the online system for each advertising account associated with the user profile of each trusted user of the network of trusted users, a timeliness of one or more payments made by each trusted user of the network of trusted users to the online system for advertising services provided by the online system, and any combination thereof.

7. The method of claim 1, further comprising:
identifying a network of untrusted users of the online system, each untrusted user of the network of untrusted users associated with a level of trustworthiness that is less than an additional threshold measure of trustworthiness; and
identifying one or more connections between the requesting user and one or more untrusted users of the network of untrusted users of the online system.

8. The method of claim 7, wherein determining the trusted connection score for the requesting user is further based at least in part on the one or more connections between the requesting user and one or more untrusted users of the network of untrusted users of the online system.

9. The method of claim 1, further comprising:
including the requesting user in the network of trusted users of the online system based at least in part on the trusted connection score.

10. The method of claim 1, further comprising:
storing the trusted connection score for the requesting user in association with the user profile of the requesting user.

11. The method of claim 1, further comprising:
in response to the trusted connection score for the requesting user not exceeding the threshold score, sending the requesting user a notification that the request to create the requested advertising account associated with the user profile of the requesting user has been denied.

12. The method of claim 1, wherein creating the requested advertising account associated with the user profile of the requesting user further comprises:
determining an amount of credit to allocate to the requested advertising account associated with the user profile of the requesting user; and
allocating the amount of credit to the advertising account associated with the user profile of the requesting user.

13. The method of claim 12, wherein the amount of credit to allocate to the requested advertising account is determined based at least in part on a requested amount of credit to allocate to the requested advertising account received from the requesting user.

14. A computer program product comprising a computer readable storage medium having instructions encoded thereon that, when executed by a processor, cause the processor to:
receive, from a requesting user of an online system, a request to create an advertising account associated with a user profile of the requesting user maintained by the online system, the advertising account associated with an amount of credit extended to the requesting user for purchasing advertising services provided by the online system;
identify a network of trusted users of the online system, each trusted user of the network of trusted users associated with at least a threshold measure of trustworthiness;
identify one or more connections between the requesting user and one or more trusted users of the network of trusted users of the online system;
determine a trusted connection score for the requesting user, the trusted connection score indicating a measure of trustworthiness of the requesting user based at least in part on the one or more connections between the requesting user and one or more of the trusted users of the network of trusted users of the online system; and
in response to the trusted connection score for the requesting user exceeding a threshold score, create the requested advertising account associated with the user profile of the requesting user.

15. The computer program product of claim 14, wherein determine the trusted connection score for the requesting user comprises:
access a graph maintained by the online system, the graph comprising a plurality of nodes and one or more edges, wherein each node corresponds to an object maintained by the online system, and each edge corresponds to a connection between two or more objects;
for each of the one or more trusted users of the network of trusted users of the online system to which the requesting user is connected:
identify in the graph a first node corresponding to the requesting user and a second node corresponding to a trusted user of the one or more trusted users of the network of trusted users;
determine a number of different paths connecting the first node and the second node, each path comprising at least the first node, the second node, and an edge; and
determine a number of edges required to connect the first node and the second node; and
determine the trusted connection score for the requesting user based at least in part on the number of different paths connecting the first node and the second node and the number of edges required to connect the first node and the second node for each of the one or more trusted users of the network of trusted users of the online system to which the requesting user is connected.

16. The computer program product of claim 14, wherein determine the trusted connection score for the requesting user comprises:
retrieve information stored in association with a connection between the requesting user and each of the one or more trusted users of the network of trusted users;
associate a weight with the connection between the requesting user and each of the one or more trusted users of the network of trusted users based at least in part on the information stored in association with the connection; and
determine the trusted connection score for the requesting user based at least in part on the weights.

17. The computer program product of claim 16, wherein the information stored in association with the connection between the requesting user and each of the one or more trusted users of the network of trusted users is selected from a group consisting of: information indicating a type of relationship between the requesting user and each of the one or more trusted users of the network of trusted users, a number of transactions between the requesting user and each of the one or more trusted users of the network of trusted users, a monetary amount associated with a transaction between the requesting user and each of the one or more trusted users of the network of trusted users, an amount of time elapsed since the connection was established between the requesting user and each of the one or more trusted users of the network of trusted users, and any combination thereof.

18. The computer program product of claim 14, wherein the threshold measure of trustworthiness is based at least in part on historical information indicating credit-worthiness of each trusted user of the network of trusted users.

19. The computer program product of claim 18, wherein the historical information indicating credit-worthiness of each trusted user of the network of trusted users includes one or more selected from a group consisting of: a number of advertising accounts associated with a user profile of each trusted user of the network of trusted users maintained by the online system, an amount of credit extended to each trusted user of the network of trusted users for advertising services provided by the online system for each advertising account associated with the user profile of each trusted user of the network of trusted users, a timeliness of one or more payments made by each trusted user of the network of trusted users to the online system for advertising services provided by the online system, and any combination thereof.

20. The computer program product of claim 14, wherein the computer readable storage medium further has instructions encoded thereon that, when executed by the processor, cause the processor to:
identify a network of untrusted users of the online system, each untrusted user of the network of untrusted users associated with a level of trustworthiness that is less than an additional threshold measure of trustworthiness; and
identify one or more connections between the requesting user and one or more untrusted users of the network of untrusted users of the online system.

21. The computer program product of claim 20, wherein determine the trusted connection score for the requesting user is further based at least in part on the one or more connections between the requesting user and one or more untrusted users of the network of untrusted users of the online system.

22. The computer program product of claim 14, wherein the computer readable storage medium further has instructions encoded thereon that, when executed by the processor, cause the processor to:
include the requesting user in the network of trusted users of the online system based at least in part on the trusted connection score.

23. The computer program product of claim 14, wherein the computer readable storage medium further has instructions encoded thereon that, when executed by the processor, cause the processor to:
store the trusted connection score for the requesting user in association with the user profile of the requesting user.

24. The computer program product of claim 14, wherein the computer readable storage medium further has instructions encoded thereon that, when executed by the processor, cause the processor to:
in response to the trusted connection score for the requesting user not exceeding the threshold score, send the requesting user a notification that the request to create the requested advertising account associated with the user profile of the requesting user has been denied.

25. The computer program product of claim 14, wherein create the requested advertising account associated with the user profile of the requesting user further comprises:
determine an amount of credit to allocate to the requested advertising account associated with the user profile of the requesting user; and
allocate the amount of credit to the advertising account associated with the user profile of the requesting user.

26. The computer program product of claim 25, wherein the amount of credit to allocate to the requested advertising account is determined based at least in part on a requested amount of credit to allocate to the requested advertising account received from the requesting user.

27. A method comprising:
receiving, from a requesting user of an online system, a request to extend an amount of credit to the requesting user, the amount of credit for purchasing advertising services provided by the online system and associated with a user profile of the requesting user maintained by the online system;
identifying one or more connections between the requesting user and one or more trusted users of a network of trusted users of the online system, each trusted user of the network of trusted users associated with at least a threshold measure of trustworthiness;
determining a trusted connection score for the requesting user, the trusted connection score indicating a measure of trustworthiness of the requesting user based at least in part on the one or more connections between the requesting user and one or more of the trusted users of the network of trusted users of the online system; and
in response to the trusted connection score for the requesting user exceeding a threshold score, extending the amount of credit to the requesting user based at least in part on the trusted connection score.
